(19) United States
(12) Patent Application Publication
(10) Pub. No.: US 2008/0040124 A1
(43) Pub. Date: Feb. 14, 2008

(54) Business Process System, Business Process Method, and Information Processing Apparatus

(75) Inventors: Masami Kinugasa, Tokyo (JP); Seiichiro Inoue, Kanagawa (JP); Takahiro Hidaka, Tokyo (JP); Hiroki Ohtani, Kanagawa (JP); Yuuki Shibuya, Kanagawa (JP); Tomoki Iwaoka, Tokyo (JP)

Correspondence Address: RABIN & Berdo, PC, 1101 14TH STREET, NW, SUITE 500, WASHINGTON, DC, 20005, US

(73) Assignees: Sony Chemicals & Information Device Corporation, Shinagawa-ku,Tokyo (JP); Ariel Networks Inc., Meguro-ku, Tokyo (JP); International Business Machines Corporation, Armonk, NY (US)

(21) Appl. No.: 10/588,781

(22) PCT Filed: Feb. 14, 2005
(86) PCT No.: PCT/JP05/02136

§ 371 Date: Apr. 20, 2007

(51) Int. Cl. G06F 13/00

(52) U.S. Cl. 705/1

(57) ABSTRACT

A business process system for transmitting and receiving various pieces of business data by connecting an indefinitely large number of enterprises through a network includes a client terminal possessed by an order source connected to an open network layer, equipped with an application for realizing a peer-to-peer network architecture, and serving as a member participating in the peer-to-peer network, an order reception database connected to a network layer inside an order reception base as a segment isolated from the open network layer, equipped with the application, connecting to the client terminal by a peer-to-peer connection upon execution of the application by the client terminal, recording data sent from the client terminal, and reading data to be sent out of the recorded data, and a node connected to an intermediate network layer at the order reception base serving as a segment isolated from the open network layer and from the inside network layer, collecting and temporally maintaining the data sent from the client terminal or the data read out of the order reception database, and transferring the data to an appropriate destination.

### TECHNICAL FIELD

This invention relates to a business process system, and a business process method for connecting an indefinitely large number of enterprises through networks to transmit and receive various pieces of business data, as well as an information processing apparatus applicable to the business process system and the business process method.

### BACKGROUND ART

Information processing apparatuses such as personal computers and various types of network technologies such as the Internet for connecting those information processing apparatuses have become remarkably widespread in recent years, and these technologies are now necessary in business activities of enterprises. In actuality, many enterprises introduce such a system as constructed through networks to effectively perform the business activities accompanied by transmitting and receiving the various pieces of business data such as data concerning ordering of information products, services, and the like.

In the system introduced to the enterprises to aid in enterprise activities accompanied by transmitting and receiving the various pieces of business data, it is necessary that many users share resources such as file-sharing, databases and the like. So-called client and server systems have been conventionally adopted for the sake of convenience in terms of management in association with an increase in network size.

As shown in FIG. 16, the client and server system is a system such that computers referred to as a client (C) issue a request for various types of services to a computer referred to as a server (S) connected to the clients (C) and realizing the core of a process. All pieces of information to be shared and transmitted and received through networks are assembled in the server (S) which provides each of the clients (C) with all pieces of information. In the client and server system, an index (a directory) for information storage and information retrieval is also managed by the implementation of a predetermined application.

As a connection structure in the client and server system, as shown in FIG. 17(A), there is a so-called RAS (Remote Access Service) connection such that a client terminal C logs into the server S by means of a dedicated line, a dial-up connection, and the like to get access thereto.

The client and server system, furthermore, can be realized even under an open environment such as the Internet by using a VPN (Virtual Private Network), as shown in FIG. 17(B). That is, in this type of client and server system, a firewall FW₁ having a VPN function is set up between the client terminal C and the external open network NT while a firewall FW₂ having a VPN function is also set up between the server S and the network NT. The interconnection between the bases can be established in a manner similar to the dedicated line, and their security can be retained, despite communications through the open network NT.

Furthermore, a typical communication through the Web can be exemplified as the client and server system, as shown in FIG. 17(C). In other words, with this type of client and server system, the firewall FW₁ is set up between the client terminal C and the external open network NT while the firewall FW₂ is also set up between the server S and the network NT. In this situation, this type of client and server system performs authentication of the server S with a certificate provided with a signature of a predetermined certificate authority and encryption of communication contents, by using an SSL (Secure Sockets Layer), to establish safe communication between a Web browser at the client terminal C and the server S.

The client and server system as described above is adopted as the system introduced to the enterprises to aid in the enterprise activities accompanied by transmitting and receiving the various pieces of business data, in which the enterprises are interconnected by using connection patterns shown in FIGS. 17(A) to 17(C) to transmit and receive various pieces of business data.

Meanwhile, in the aforementioned client and server system, the connection pattern through a closed network as shown in FIG. 17(A) requires the dedicated line for each individual enterprise, thereby causing a problem such as an increase of communication costs.

On the other hand, the client and server system can be realized even under an open environment such as the Internet, as shown in FIG. 17(B), thereby being able to cut down communication costs. This type of client and server system, however, requires introduction of a VPN application as well as allocation of a port to pass the firewall, and because the internal protocol for connecting the client terminal to the server remains undisclosed, there raises a problem such as serious impediments in the way of introduction of the VPN for indefinite users.

Furthermore, in the client and server system, the connection pattern through the Web as shown in FIG. 17(C) has a problem such as a slow response since individual screens to be displayed on a display screen of the client terminal are downloaded from the server. Yet further, this type of client and server system requires the client terminal to be connected to the server at all times, so that it is necessary to start again from input of data using the client terminal in the case of disconnection during communication.

The client and server system, furthermore, requires the server to manage all information, causing such problems as high costs and extremely complicated maintenance operation despite the connection pattern of the system.

From the aforementioned viewpoint, the client and server system using a mechanism such as the dedicated line or the Internet has been limited to transactions among the specific enterprises and transactions among enterprises and general customers. In other words, the client and server system cannot construct such a system at low cost, which can bear transactions among an indefinitely large number of enterprises at ordinary operation speed.

For the reasons stated above, a so-called peer-to-peer system has became a focus of attention, which is a network pattern capable of effectively utilizing the client terminal which is becoming otherwise idling resource to encourage cost-reduction resulting from simultaneous realization of both dispersed load and serverless environment, and reduction of communication-cost resulting from the open network.

This peer-to-peer system is a system in which information is directly transmitted and received between the computers (C) connected to one another through the network, as shown in FIG. 18(A). In this peer-to-peer system, the server for storing the information and a center directory for intensively managing the index do not exist, and each computer resource or various types of services such as a so-called file sharing service can be shared by implementation of the predetermined application by each of the computers (C).

As another pattern in the peer-to-peer system, a hybrid form has been known, as shown in FIG. 18 (B), in which the server (S) is formed together and communication depends on the mediation of the center directory. In the peer-to-peer system of this hybrid system, the client (C) joining the network registers a resource index of itself in the central server (S). In this peer-to-peer system, the client (C) seeks the resource of another client (C) by using directory service provided by the server (S). In other words, in this peer-to-peer system, although the information itself of the file or the like remains stored in a local drive of each client (C), access to the local driver is allowed by placing existence of this information as index information in the public such as other clients (C).

This peer-to-peer system has not only an advantage such as the aforementioned cost-reduction but also such an advantage that high speed responsivity of a screen makes fulltime connection unnecessary since the application is executed by each of the client terminals.

Meanwhile, Japanese Patent Laid-Open Nos. 2003-87267 and 2002-135457, for example, have disclosed such systems using the aforementioned type of peer-to-peer system.

In the system that the enterprises have already introduced, however, connection patterns usually differ from one enterprise to another and data formats used differ as well. Therefore, it is considered impossible to apply the peer-to-peer system to such a system as introduced to the enterprises to aid in enterprise activities accompanied by transmitting and receiving the various pieces of business data.

Furthermore, the peer-to-peer system based on the client terminal by using the open network has a possibility of causing network disconnection or instability in each computer. The peer-to-peer system, therefore, cannot handle such enterprise business as caused by daily transmission and reception of the large amount of data and particularly, occurrence of financial transactions.

Yet further, when thought is given to transmissions and receptions of the business data on the transactions among the enterprises, the trading partners already constructed an existing system in many cases. In those cases, construction of such a system that the data is transferred from a system of a trading partner depends on the trading partner. Therefore, it is assumed that the presence of the existing system becomes a barrier to the peer-to-peer system with geared for widespread enterprise transaction even where such a peer-to-peer system can be constructed, thereby not allowing the peer-to-peer system to be effectively operated.

### DISCLOSURE OF THE INVENTION

This invention is accomplished in consideration of the aforementioned situation, and it is an object of the invention to provide a business process system, a business process method, and an information processing apparatus capable of realizing transactions among an indefinitely large number of enterprises under a serverless condition at a low cost with high security, which has been considered impractical with conventional systems, by introducing a peer-to-peer technology into a system of B2B (Business to Business).

According to this invention for achieving the aforementioned objects, a business process system for transmitting and receiving various pieces of business data by connecting a large number of enterprises through a network includes a client terminal possessed by an order source connected to an open network layer, the client terminal being equipped with an application for realizing a peer-to-peer network architecture, a collector node connected to an intermediate network layer at an order reception base serving as a segment isolated from both the open network layer and a network layer located inside the order reception base, establishing a peer-to-peer connection with the client terminal upon execution of the application by the client terminal, collecting and temporally maintaining the data sent from the client terminal, and then transferring the data to an appropriate destination, an order reception database connected to the inside network layer as a segment isolated from both the open network layer and the intermediate network layer, equipped with the application, and recording the data transferred from the collector node.

The business process system according to the invention records in the order reception database at the order reception base the data sent from the client terminal connected to the open network layer through the collector node connected to the intermediate network layer at the order reception base as a segment insolated from both the open network layer and from the inside network layer at the order reception base to establish a peer-to-peer connection with the client terminal.

Therefore, in the business process system according to this invention, the client terminal executes the application to possibly reduce the load on the order reception database and hence bring remarkable improvement in the performance, and intervention of the collector node prevents direct access to the order reception database to allow remarkable improvement in security as well. Furthermore, in the business process system according to this invention, the collector node at the intermediate network layer temporarily maintains the data from the client terminal and then transfers the data to the order reception database, thereby eliminating necessity for reinput of the data by the client terminal even in the case of disconnection of the connect session between the order reception database and the client terminal during communication, thereby resulting in reliable communication.

The application for realizing a peer-to-peer network architecture is composed of a screen function for providing a data recording function and a data display function, a translation function for receiving data recorded upon execution of the screen function or arbitrarily-created data, and for converting the data into a format comprehensible to the order reception database, a data carrier function as a base function for maintaining security beyond a firewall as well as reliably transmitting and receiving data, and a database management function for receiving data received upon execution of the data carrier function, for capturing the data in a predetermined area of a database, and for retrieving data recorded in the database.

The client terminal executes the translation function to receive the data recorded upon execution of the screen function or the arbitrarily-created data and to convert the data into the format comprehensible to the order reception database. The client terminal executes the data carrier function to establish a connect session to the order reception database through the node and to send the data converted with the translating function.

The order reception database executes the data carrier function to establish the connect session to the client terminal through the node and to receive data sent from the client terminal. The order reception database executes the database management function to receive and capture in a predetermined area of the database the data received upon execution of the data carrier function and to retrieve data recorded in the database.

The business process system according to this invention can coexist with an existing system even where an enterprise as an order source has already constructed the existing system. The business process system therefore can realize transactions among an indefinitely large number of enterprises under a serverless condition at a low price with high security by using the peer-to-peer technology, which has been considered impractical.

The business process system according to this invention, further includes an order reception base terminal connected to an in-house network at an order reception base connected to the open network layer, the intermediate network layer, and the inside network layer though a firewall, the order reception base terminal equipped with the application. The order reception base terminal displays on a screen ordering data received through the node according to ordering to manage an ordering condition.

Therefore; the business process system according to this invention enables the order reception base to manage at least the ordering condition, thereby making it possible to smoothly make corresponding the other business processes.

Meanwhile, the open network layer is defined as a WAN layer, the intermediate network layer is defined as a DMZ layer, and the inside network layer is defined as a LAN layer.

A business process transmits and receives various pieces of business data by connecting a large number of enterprises through a network, in which a client terminal possessed by an order source connected to an open network layer, equipped with an application for realizing a peer-to-peer network architecture, and serving as a member participating in a peer-to-peer network, converts data recorded through a screen or arbitrarily-created data into a format comprehensible to an order reception database at an order reception base and sends the converted data upon establishment of a connect session to the order reception database. In this business process method, a collector node connected to an intermediate network layer at the order reception base as a segment isolated from both the open network layer and an inside network layer at the order reception base, and establishing a peer-to-peer connection with the client terminal upon execution of the application by the client terminal, collects and temporarily maintains data sent from the client terminal or data read out from the order reception database to transfer the data to an appropriate destination. In this business process method, the order reception database connected to the inside network as a segment isolated from both the open network layer and the intermediate network layer, and equipped with the application, records data which was transferred from the collector node.

In the business process system according to this invention, the client terminal connected to the open network layer executes the application to possibly reduce the load on the order reception database and hence bring remarkable improvement in the performance, and intervention of the collector node prevents direct access to the order reception database to enable remarkable improvement in security as well. Furthermore, in the business process system according to this invention, the collector node at the intermediate network layer temporarily maintains the data from the client terminal and then transfers the data to the order reception database, thereby eliminating necessity for reinput of the data by the client terminal even in the case of disconnection of the connect session between the order reception database and the client terminal during communication, thereby resulting in reliable communication.

An information processing apparatus installed to a business process system connecting a large number of enterprises through a network and transmitting and receiving various pieces of business data, serving as a member participating in a peer-to-peer network, equipped with an application for realizing a peer-to-peer network architecture, and connected to an open network, the information processing apparatus includes a screen section for executing a screen function defined as a function of the application and providing a data recording function and a data display function, a translation section for executing a translation function defined as a function of the application, receiving the data recorded upon execution of the screen function or the arbitrarily-created data, and converting the data in a format comprehensible to an order reception database at an order reception base, a data carrier section defined as a function of the application, for executing a data carrier function for transmitting and receiving the data with the node as a connection destination. The translation section executes the translation function to convert the data recorded upon execution of the screen function or the arbitrarily-created data in a format comprehensible to the order reception database, and the data carrier section executes the data carrier function to send the converted data by establishing a connect session to the order reception database.

The business process system according to this invention executes the application to enable reduction of the load on the order reception database and hence remarkable improvement in the performance, while coexisting with an existing system even where an enterprise as an order source has already constructed the existing system. The business process system therefore can realize transactions among a large number of enterprises under a serverless condition at a low price with high security by using the peer-to-peer technology, which has been considered impractical.

An information processing apparatus for achieving the aforementioned objects is installed to a business process system connecting an indefinitely large number of enterprises through a network and transmitting and receiving various pieces of business data. The information processing apparatus is connected to an intermediate network at an order reception base as a segment isolated from both an open network layer and an inside network at the order reception base, the open network layer connected to a client terminal equipped with an application for realizing a peer-to-peer network architecture, serving as a member participating in a peer-to-peer network, and possessed by an order source, and the information processing apparatus collects and temporally maintains data sent from the client terminal or data read out from the order reception database at the order reception base connected to the inside network layer and transfers the data to an appropriate destination.

The information processing apparatus according to this invention temporally maintains the data sent from the client terminal executing the application and then transfers the data to the order reception database, thereby enabling reduction of the load on the order reception database and hence remarkable improvement in the performance, and direct access to the order reception database is avoided to enable remarkable improvement in security as well. Furthermore, the business process system according to this invention eliminates necessity for reinput of the data by the client terminal even in the case of disconnection of the connect session between the order reception database and the client terminal during communication, thereby resulting in reliable communication.

An information processing apparatus for achieving the aforementioned objects is installed to business process system connecting a large number of enterprises through a network and transmitting and receiving various pieces of business data, connected to an inside network layer at an order reception base isolated from an open network layer connected to a client terminal equipped with an application for realizing a peer-to-peer network architecture and possessed by an order source, serving as an order reception database at the order reception base, and equipped with the application. The information processing apparatus includes a data carrier section for executing a data carrier function for transmitting and receiving data with the node as a connection destination, and a database management section for executing a database management function as a function of the application, receiving the data received upon execution of the data carrier function, capturing the data in a predetermined area of a database, and retrieving the data recorded in the database. The data carrier section executes the data carrier function to establish a connect session to the client terminal through the collector node connected to an intermediate network layer at an order reception base as a segment isolated from both the open network layer and the inside network layer and to receive data sent from the client terminal after conversion in a format comprehensible to the database, and the database management section executes the database management function to receive the data received upon execution of the data carrier function, to capture the data in the predetermined area of the database, and to retrieve data recorded in the database.

In the information processing apparatus according to this invention, the client terminal connected to the open network executes the application, thereby reducing the load on the order reception database and hence bringing remarkable improvement in the performance, while the information processing apparatus records the data transferred from the collector node, thereby preventing direct access to the order reception database, resulting in remarkable improvement in security as well. The information processing apparatus according to this invention, furthermore, eliminates necessity for reinput of the data by the client terminal even in the case of disconnection of the connect session between the order reception database and the client terminal during communication, thereby resulting in reliable communication.

According to this invention, such transactions among an indefinitely large number of enterprises under a serverless condition, which has been considered impractical can be realized at a low price with high security by using the peer-to-peer technology.

### BRIEF DESCRIPTION OF THE DRAWINGS

FIG. 1 is a view illustrating a concept of a peer-to-peer architecture applied to a business process system according to a first embodiment of this invention;

FIG. 2 is a view illustrating a status that a resource is sought and found in the architecture shown in FIG. 1;

FIG. 3 is a view illustrating a first connection pattern which is prepared as an access session according to a network pattern in the architecture shown in FIG. 1;

FIG. 4 is a view illustrating a second connection pattern which is prepared as an access session according to a network pattern in the architecture shown in FIG. 1;

FIG. 5 is a view illustrating a third connection pattern which is prepared as an access session according to a network pattern in the architecture shown in FIG. 1;

FIG. 6 is a view illustrating a connection pattern by the peer-to-peer system applied to the business process system according to embodiments of this invention;

FIG. 7 is a view illustrating function of an application implemented in the business process system according to embodiments of this invention;

FIG. 8 is a view illustrating an example of the business process system constructed by providing a plurality of sessions between two nodes as shown in FIG. 7, in which an application is implemented according to embodiments of this invention;

FIG. 9 is a view illustrating a network structure in the detailed business process system rooted a standard model of a transaction between an enterprise and a large number of enterprises according to embodiments of this invention;

FIG. 10 is a view illustrating a flow of product-life cycle to which the business process system as shown in FIG. 9 can be applied;

FIG. 11 is a view illustrating a sequence to receipt of an order through a client terminal in the case of where an end customer having the client terminal has an original system for ordering and purchasing information products or services;

FIG. 12 is a view illustrating a sequence to receipt of an order through a client terminal in the case of where an end customer having the client terminal doe not have an original system for ordering and purchasing information products or services;

FIG. 13 is a view illustrating as an example of a series of businesses in the business process system according to embodiments of this invention, a series of procedural steps from order through a channel by the end customer to a delivery date reply by an order-receipt base, especially illustrating a process from the order to the order-receipt in the series of procedural steps;

FIG. 14 is a view illustrating an example of a delivery date reply dialog displayed on a display screen of an order-receipt base terminal;

FIG. 15 is a view illustrating as an example of a series of businesses in the business process system according to embodiments of this invention, a series of procedural steps from order through a channel by the end customer to a delivery date reply by an order-receipt base, especially illustrating a process from the order to the delivery date response in the series of procedural steps;

FIG. 16 is a view illustrating a basic structure of a client and server system;

FIG. 17(A) is a view illustrating an RAS connection as a connection pattern in the client and server system;

FIG. 17(B) is a view illustrating a connection using a VPN as a connection pattern in the client server system;

FIG. 17(C) is a view illustrating a typical connection through the Web as a connection pattern in the client and server system;

FIG. 18(A) is a view illustrating a basic structure of a pure-type peer-to-peer system as a basic structure of the peer-to-peer system; and

FIG. 18(B) is a view illustrating a basic structure of a hybrid-type peer-to-peer system as a basic structure of the peer-to-peer system.

### BEST MODE FOR CARRYING OUT THE INVENTION

Hereinafter, with reference to the drawings, specified embodiments to which this invention is applied are described in detail.

This embodiment is about a business process system in which an indefinitely large number of enterprises are connected to one another by a so-called serverless peer-to-peer network to receive various pieces of business data such as data on ordering of information products, services, and the like.

A concept of a peer-to-peer technology applied to this business process system will be explained before explanation of an entire structure of the business process system.

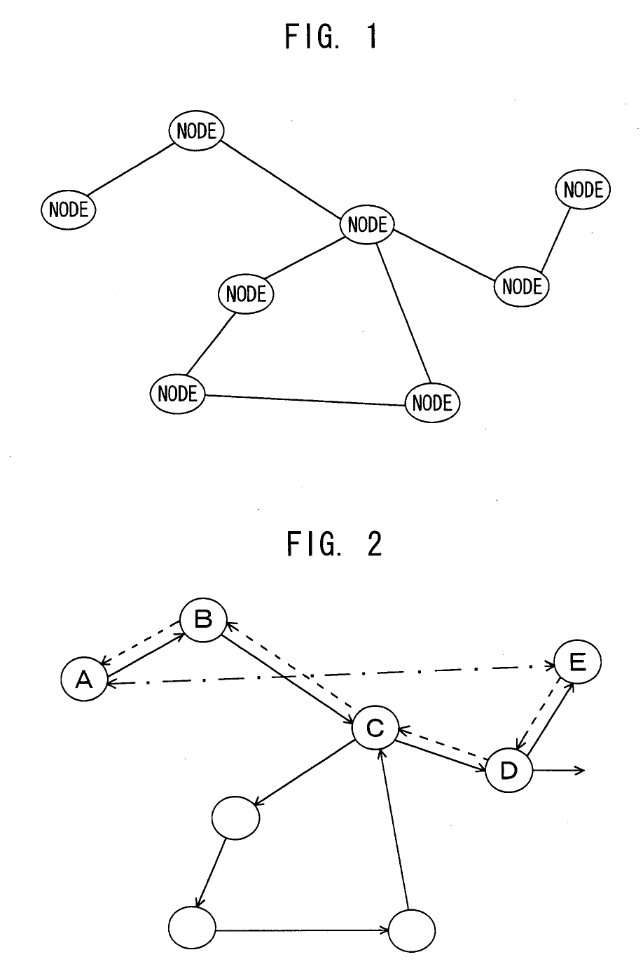

A peer-to-peer architecture applied to the business process system is defined by nodes, i.e., a group of computers, as shown in FIG. 1. In the architecture, the nodes form a topology while providing a plurality of sessions to one another, respectively. Meanwhile, this normal session means connection to a TCP/IP (Transmission Control Protocol/Internet Protocol) for maintaining communication in the application level. In this architecture, the nodes form a fulltime topology by connecting to one another in the aforementioned manner, thereby forming paths routing a protocol. In this case, in this architecture, each of the nodes does not connect to all other nodes but connects to nearby nodes only. In this architecture, each of the nodes can become linked with unknown nodes through the nearby nodes upon transmission of a protocol such as a command on this connect session.

The so-called client and server system is based on a premise that each of the client terminals recognizes the server to which the client terminal itself connects. In the peer-to-peer system, however, it is important that each node recognizes another node to which the node contacts first in order to participate in a network. In this architecture, in the case of participating in the network, each node obtains a predetermined attribute file and connection file concerning another node to which the node intends to connect. In this architecture, a protocol is transmitted on a connect session where connection to a single node is permitted. During the course of this process, each node can obtain the information on another node to set this other node to a new connection-destination candidate. In the peer-to-peer system, each node can participate in or pull out of the network freely, so that another node to which the node directly connects changes dynamically. Therefore, each node autonomously changes a connection-destination thereof so as to optimize connection between the nodes in this architecture.

In this architecture, upon completion of a setup, each member is to participate in a cyberspace referred to as a room where the members sharing the information gather. In this architecture, participation in this room makes those members be an actual member participating in the network. As a method for participating in this room, the member may be invited by another member peer or may create a room by themself and invite the peer to the room. This room is defined as a so-called VPN (Virtual Private Network) in which only the peers each of which approves sharing of the information in the cyberspace participate, and allows such participation over physical limits to the network, such as LAN (Local Area Network), a router, and the like.

In this architecture, upon establishment of connection, it enables the resource to be sought and found.

The node that tries to seek the resource sends a predetermined command to a nearby node provided with a connect session by the node. This command, in which a command ID for identifying the command and a resource ID for identifying the resource are described, plays a part as an inquiry command informing a node as a destination of this command about a statement such as “please notify if possessing a recource to be sought”.

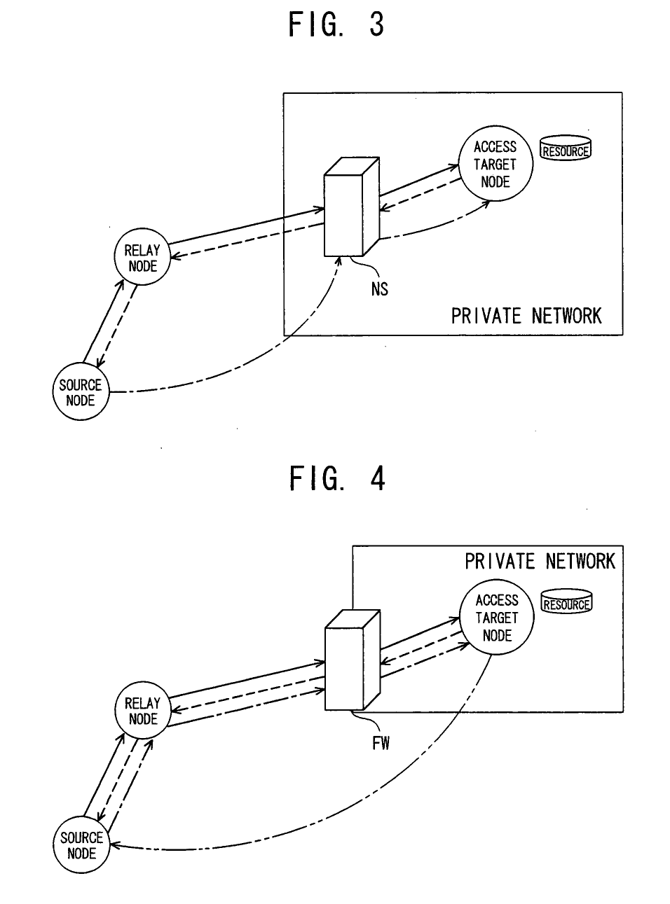

The node having received the inquiry command makes a determination as to possession of the corresponding resource by seeking the index of the resources that the node itself possesses. The node having received the inquiry command transfers this inquiry command to a nearby node other than the node having set this inquiry command, in the case of not possessing the resource. In this architecture, as indicated by the arrow in a solid line shown in FIG. 2, for example, the inquiry command is transferred to a nearby node from a node A until a time when the resource that the node A is to seek is found.

On the other hand, the node having received the inquiry command returns a predetermined response protocol in the case of possessing the resource. In this architecture, where the resource sought by the node A is found at the node E, as indicated by the arrow in a broken line shown in FIG. 2, the response protocol is transferred in the reverse direction to the path through which the inquiry command has been transmitted, i.e., in the order of a node D, a node C, and a node B.

Herein, in the response protocol having been returned from the node possessing the resource, an address of the node, the resource ID indicating a resource status, and a revision number are described. Therefore, in this architecture, in the case of obtaining access information to the resource possessed by the node E upon receiving the response protocol, the node A can get direct access to the node E, as indicated by the arrow in a single dotted chain line in FIG. 2. As described above, in this architecture, an access session independent from the contact session is formed as actual access to the resource, thereby being able to prevent a network bandwidth from becoming scarce.

Particularly, in the architecture, four types of mechanisms are prepared to speed up the seeking speed of the resource. First, in the case of transferring the command transferred from a node, the command is not transferred to the node that transferred the command, as described above. Second, a node does not transfer the command that the node has transferred once, even in the case of reception of the command from another node. Third, furthermore, a so-called Time To Live (TTL) is set to the command. Fourth, yet further, each node catches other than the self-resource index, existence of resources of other nodes through which the command is transferred. In this architecture, formation of those mechanisms can improve a speed of response and efficiency of routing.

In the peer-to-peer system, a firewall for placing limitation on a communication port, a network using private IP (Internet Protocol) addresses, and the like generally may become an obstacle. This is because access to the computer inside the firewall from outside of the firewall is basically impossible.

Herein, in this architecture, under an NAT (Network Address Translation) or a firewall environment, connection is realized by providing a contact session from the inside to the outside of the NAT server or the firewall. In this architecture, a plurality of connection patterns is prepared as an access session according to network patterns. In this architecture, those network patterns are automatically recognized to realize the optimum access means.

As the first connection pattern, there is a pattern corresponding to a private IP address using a port forwarding function. The NAT server generally has such a function as transferring the data having been sent to a specific port to another port. Herein, in this architecture, setting for forwarding the port for the architecture is previously made using the aforementioned function. Thus, when responding to the aforementioned response protocol, the NAT server returns node information of both a private IP address and a masquerade node.

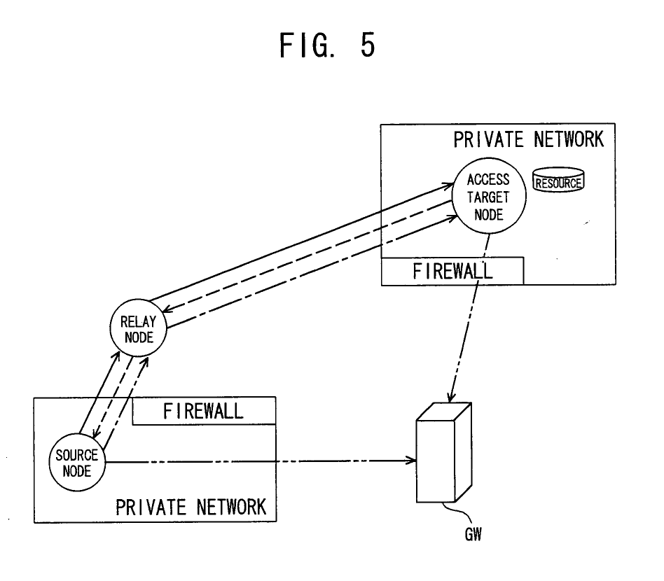

To be more specific, in this architecture, where the resource that a source node intends to seek is possessed by an access target node belonging to a private network located inside a NAT server NS, as indicated by the arrow in a solid line shown in FIG. 3, for example, the inquiry command is transferred from the source node through a relay node and the NAT server NS to the access target node. Accordingly, in this architecture, as indicated by the arrow in a broken line shown in FIG. 3, the response protocol is transferred from the access target node though the NAT server NS and the relay node to the source node. At this time, the masquerade node information set by the NAT server NS is informed together with the private IP address by the NAT server NS. Therefore, in this architecture, even where a peer corresponding to the private IP address cannot be provided with an access session from an outside, as indicated by a single dotted chain line shown in FIG. 3, it is possible to switch access to the masquerade node based on a global IP address.

As the second connection pattern, there is a pattern capable of providing a session for the access target node belonging to the private network inside the firewall. That is, in this architecture, where the access session cannot be opened under a situation where access to a source node inside the firewall from outside of the firewall is intended, the access session can be provided by the node inside the firewall.

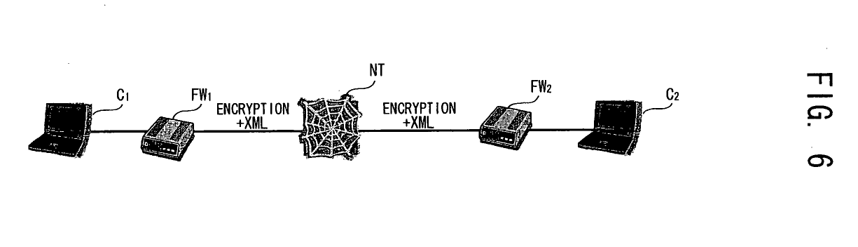

To be more specific, in this architecture, as shown in FIG. 4, for example, where the resource which the source node intends to seek is possessed by the access target node belonging to the private network inside the firewall FW, the inquiry command is transferred from the source node through the relay node and the firewall FW to the access target node, as indicated by the arrow in a solid line shown in FIG. 4. Accordingly, in this architecture, as indicated by the arrow in a broken line shown in FIG. 4, the response protocol is transferred from the access target node through the firewall FW and the relay node to the source node. Furthermore, in this architecture, as indicated by a single dotted chain line shown in FIG. 4, a predetermined access request command is transferred from the source node through the relay node and the firewall FW to the access target node in the reverse direction to the path through which the response protocol has been transmitted. In this architecture, furthermore, as indicated by the arrow in a double dotted chain line shown in FIG. 4, the access target node inside the firewall FW provides the source node outside the firewall FW with the access session according to the access request command. Thus, in this architecture, it becomes possible to execute access from the source node through the access session to the access target node.

Yet further, as the third connection pattern, there is a pattern in which neither the access target node nor the source node can provide the session. For example, where both the source node and the access target node are separately located inside the respective firewalls, neither of them can provide the session. In this case, a third node located in an environment where the session can be provided by both the access target node and the source node is installed as a gateway node in this architecture, thereby being able to carry out communication through the gateway.

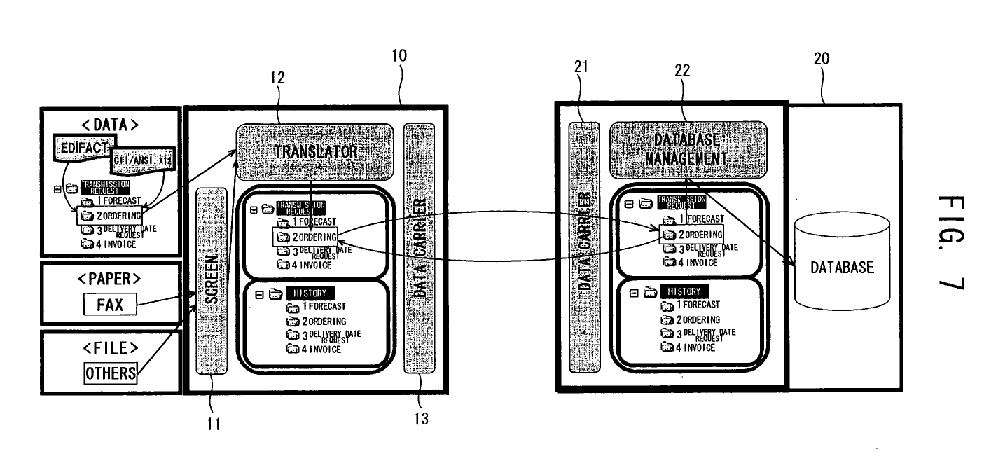

To be more specific, in this architecture, as shown in FIG. 5, for example, the resource, which the source node belonging to the private network inside the firewall is to seek, is possessed by the access target node belonging to a separate private network inside a firewall, the inquiry command is transferred from the source node through the relay node and the firewall to the access target node, as indicated by the arrow in a solid line shown in FIG. 5. Accordingly, in this architecture, as indicated by the arrow in a broken line shown in FIG. 5, the response protocol is transferred from the access target node through the firewall and the relay node to the source node. Furthermore, in this architecture, as indicated by the arrow in a double dotted chain line shown in FIG. 5, the source node provides the access session between the source node and the gateway node GW, as indicated by the arrow in a double dotted chain line shown in FIG. 5. In this architecture, as indicated by the arrow in a single dotted chain line shown in FIG. 5, a predetermined gateway request command, in which such information as an IP address of the gateway node GW and the like is described, is transferred from the source node through the relay node and the firewall to the access target node in the reverse direction to the path through which the response protocol has been transmitted. Accordingly, in this architecture, as indicated by the arrow in a double dotted chain line shown in FIG. 5, the access target node inside the firewall provides the access session for the gateway node GW outside the firewall according to the gateway request command. In this architecture, the gateway node GW internally joins the session from the source node to the session from the access target node. As described above, in this architecture, the gateway node GW is interposed between the source node and the access target node to join the access sessions therefrom, thereby being able to execute access from the source node to the access target node.

The business process system according to this embodiment of the invention is realized with application of the aforementioned peer-to-peer network architecture. Explained hereinafter is this business process system.

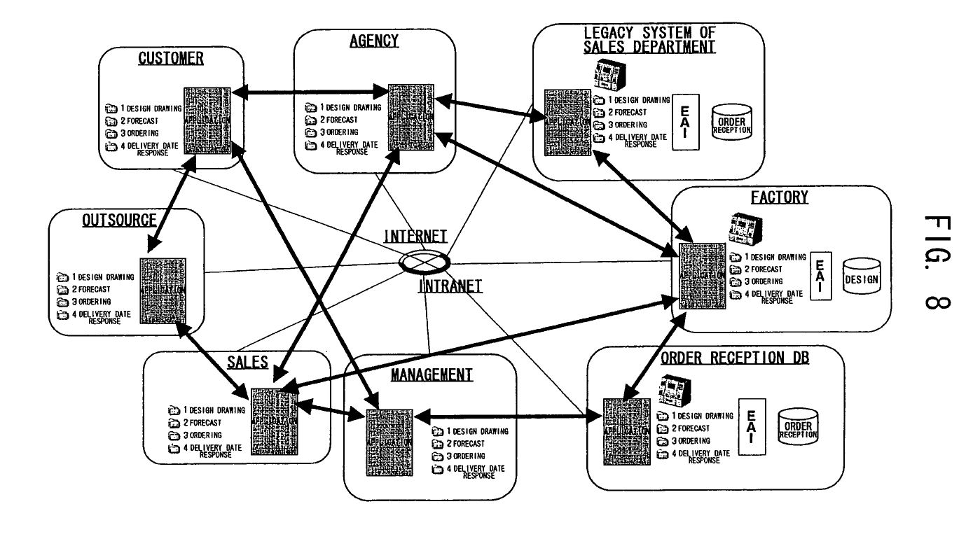

On a concept of this business process system, as shown in FIG. 6, a firewall FW₁ is installed between a computer C₁ possessed by an order source such as an end customer or an agency thereof and an external open network NT while a firewall FW₂ is also installed between a computer C₂ such as an order reception database possessed by an order reception base and the network NT by applying the aforementioned peer-to-peer network architecture, and thus the data described in a predetermined language such as a so-called XML (eXtensible Markup Language) encrypted in a predetermined manner is transmitted and received between the computers C₁, C₂. In this business process system, the application realizing the aforementioned peer-to-peer network architecture is implemented in each of the computers C₁, C₂ that execute the application using a CPU (Central Processing Unit) or the like, thereby enabling the data to be sent to a designated area. Thus, each of the computers C₁, C₂ manages the data and does not require installation of the server, thereby resulting in excellent input responce through a screen to make fulltime connection unnecessary.

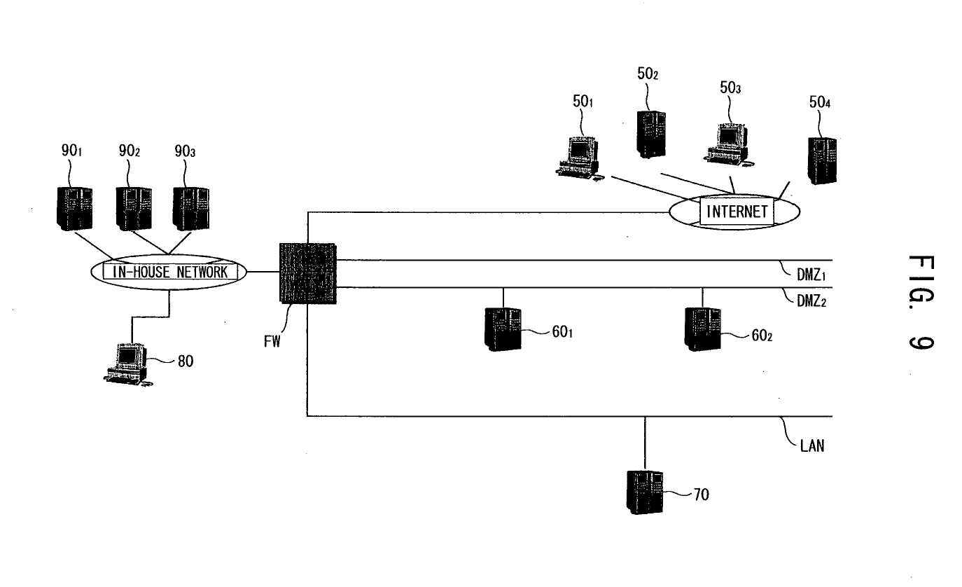

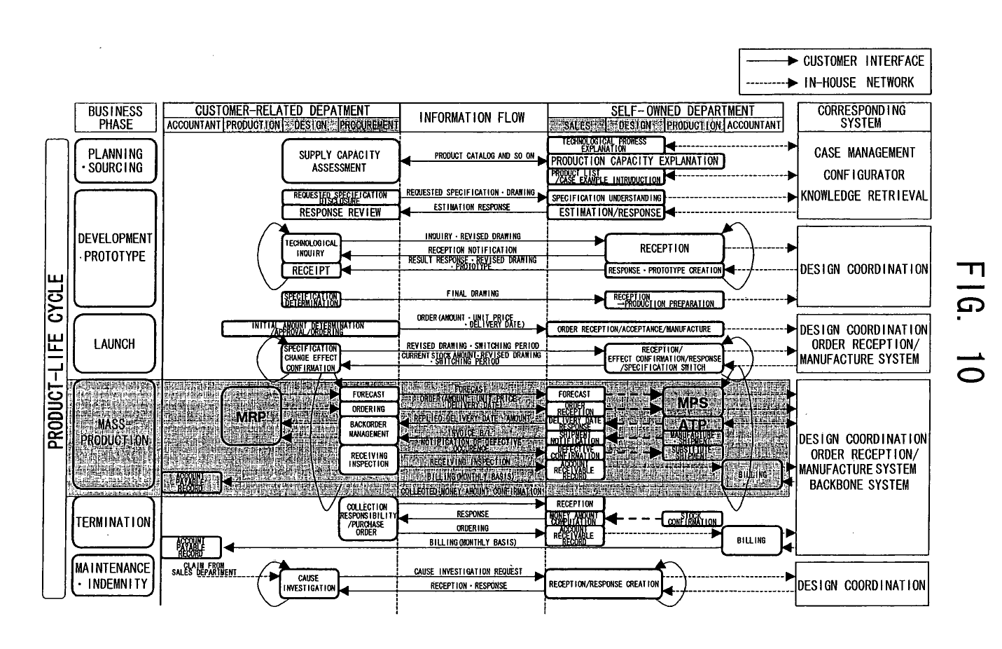

To be more specific, in the business process system, a function of the implemented application is categorized into four functions, i.e., a screen section 11, a translator 12, data carrier sections 13, 21, and a database management section 22, as shown in FIG. 7.

First, as a function executed by the client terminal 10, there is the screen section 11, the translator 12, and the data carrier section 13.

The screen section 11 is executed in the case where the end customer or the agency possessing the client terminal 10 does not have an original system for ordering and purchasing products or services, and provides a function for registering or displaying the data through the predetermined screen. That is, in the case of not having the original system, the end customer or the agency possessing the client terminal 10 normally orders the products or services based on a ledger such that the information is written on paper media by, e.g., a facsimile or on other media such as data files in an original format. In this business process system, the information entered in those various media can be input as the data through the predetermined screen and the data can be displayed by executing this function of the screen section 11. The data registered through the screen section 11 is passed to the translator 12.

The translator 12 is receives the data registered upon execution of the screen section 11 to convert the received data into a format comprehensible to the order reception database of the order reception base. Furthermore, where the end customer or the agency possessing the client terminal 10 has an original system for ordering and purchasing the information products or services, the translator 12 can directly receive data files in various formats arbitrarily created by the system, such as a so-called EDIFACT (Electronic Document Interchange For Administration, Commerce and Transportation) format, a so-called EIAJ (Electronic Industries Association of Japan) format including a so-called CII (Center for the Information of Industry), an ANSI (American National Standards Institute). X12 format, or other customers' original formats, and then the translator 12 can convert such data into a format comprehensible to the order reception database of the order reception base. The business data converted by the translator 12 is classified and stored into predetermined directories in a local device of the client terminal 10.

The data carrier section 13 has a base function for reliably transmitting and receiving various pieces of business data such as a so-called forecast as an order forecast or ordering data beyond the firewall while maintaining security. Where retrieving the business data from the storage area, the data carrier 13 establishes the connect session to an area which is to store the business data in an order reception database 20 and sends this business data.

On the other hand, as a function executed by the order reception database 20, there are the data carrier section 21 and the database management section 22.

The database carrier section 21 has a base function for reliably transmitting and receiving various pieces of business data beyond the firewall while maintaining security, in a manner similar to the data carrier section 13. The data carrier section 21 receives the business data sent from the client terminal 10. The data received through the data carrier 21 is passed to the database management section 22.

The database management section 22 has a function such as receiving the business data received through the data carrier section 21 to capture this business data in a predetermined area of the database or such as retrieving the data stored in the database.

Meanwhile, those functions are implemented as an application in all of the computers regardless of the order source or the order target (the order reception base). FIG. 7, however, shows those functions logically divided into a function executed by the client terminal 10 configured as the information processing apparatus such as a computer possessed by the order source such as the end customer or the agency thereof and a function executed by the order reception database 20 possessed by the order target, for convenience of explanation. In other words, the client terminal 10 executes functions of the data carrier 21 and the database management section 22 in the case of being a data-receiving side while the order reception database 20 executes functions of the screen section 11, the translator 12, and the data carrier section 13 in the case of being a data-sending side.

In the business process system, the plurality of sessions between two nodes in which the aforementioned application is installed are provided, thereby making the peer-to-peer connection practicable between each of departments in a single enterprise, such as an order reception database, a management department, a marketing department, a sales department having a legacy system such as a so-called EAI (Enterprise Application Integration), and a factory producing information products and the like, which are all connected to an internet such as the predetermined intranet, and an end customer, an agency, and an outsourcee which are all connected to an open network such as the Internet. Therefore, the peer-to-peer connection becomes practicable among the departments or among the end customers, the agencys, and the outsourcees.

Hereinafter, such a business process system adopting the aforementioned concept will be explained in detail, as a standard model of a transaction between an enterprise and an indefinitely large number of enterprises.

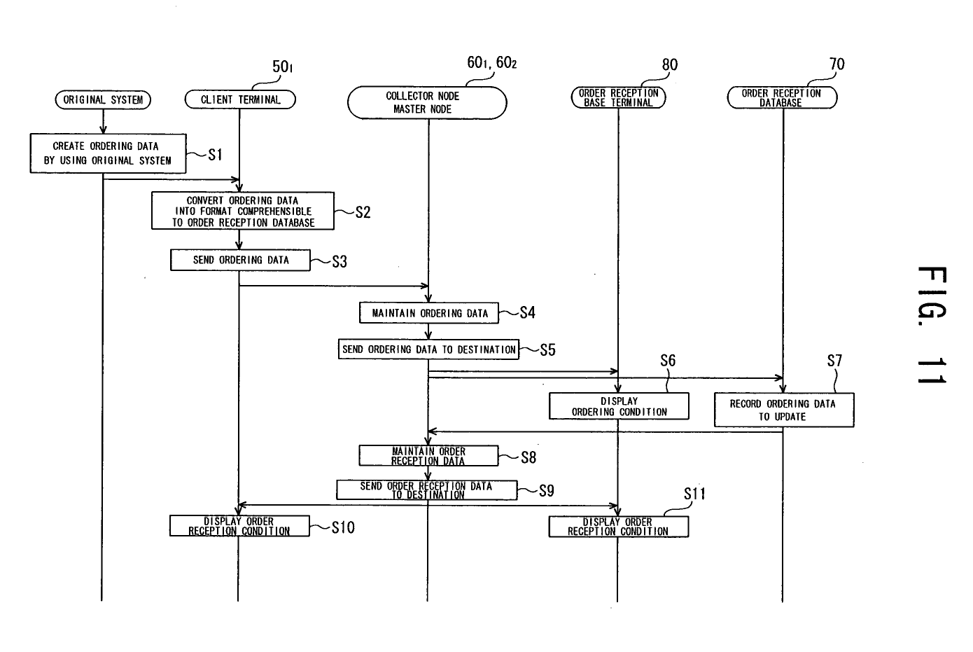

As shown in FIG. 9, this business process system has a plurality of client terminals 50₁, 50₂, 50₃, 50₄ possessed by the end customer, the agency, and the enterprise such as an affiliate, connected to an open network such as the Internet, a collector node 60₁ and a collector node 60₂ configured as an information processing apparatus such as a computer connected to a so-called DMZ (DeMilitarized Zone) layer defined as a segment isolated from both an external open network layer and an internal LAN layer through the firewall FW, an order reception database 70 configured as an information processing apparatus such as a computer connected to a LAN defined as a segment isolated from both the external open network and the DMZ layer through the firewall FW, an order reception base terminal 80 configured as an information processing apparatus such as a computer connected to a predetermined in-house network connected through the firewall FW, and a plurality of client terminals 90₁, 90₂, 90₃ possessed by an overseas subsidiary company or an overseas sales company connected to the in-house network as well.

From among those nodes, a system composed of the collector node 60₁, the master node 60₂, the order reception database 70, the order reception base terminal 80, and the client terminals 90₁, 90₂, 90₃ is in the possession of an enterprise as an order reception base receiving an order and providing information products or services, while the client terminals 50₁, 50₂, 50₃, 50₄ are terminals operated by a plurality of partner enterprises as an order source ordering the information products or services to the enterprise, respectively.

Each of the client terminals 50₁, 50₂, 50₃, 50₄ corresponds to the client terminal 10 as previously shown in FIG. 7 and is a member participating in the peer-to-peer network in which the application realizing the aforementioned peer-to-peer network architecture is implemented. Each of the client terminals 50₁, 50₂, 50₃, 50₄ operates basically as a stand-alone terminal upon execution of the application. The enterprise possessing those client terminals 50₁, 50₂, 50₃, 50₄ conducts business transactions with the enterprise providing the information products or services through the open network such as the Internet by transmitting and receiving the business data using those client terminals 50₁, 50₂, 50₃, 50₄.

The collector node 60₁ is a node possessed by the enterprise at the order reception base receiving the order and providing the information products or services and is not equipped with the application realizing the aforementioned peer-to-peer network architecture. The collector node 60₁ exists together with the master node 60₂, as a background environment in the network realizing the peer-to-peer connection between the client terminals 50₁, 50₂, 50₃, 50₄ and the order reception database 70. To be more specific, the collector node 60₁ is connected to the DMZ layer defined as a segment isolated from both the external open network layer through the firewall FW and the internal LAN layer connected to the order reception database 70. The collector node 60₁ may be a public node from the viewpoint of the client terminals 50₁, 50₂, 50₃, 50₄ or may be a computer different from the public node.

In this invention, the collector node 60₁ is a node that is up and running at all times so as to be able to obtain the information even where the other members are shut off, as well as collecting the information from each member voluntarily. To be more specific, where each of the client terminals 50₁, 50₂, 50₃, 50₄ establishes the peer-to-peer connection with the order reception database through the firewall FW upon execution of the application, the collector node 60₁ collects the information sent from each of the client terminals 50₁, 50₂, 50₃, 50₄, thereby maintaining the information temporarily. Furthermore, where a new product is developed and the information on this product is added to the order reception database 70, for example, the collector node 60₁ performs polling periodically to send the aforementioned information to each of the client terminals 50₁, 50₂, 50₃, 50₄, thereby collecting the data read from the order reception database 70 to maintain the data temporarily. Meanwhile, the collector node 60₁ can also have a function of a so-called HTTP (Hyper Text Transfer Protocol) bridge or the gateway node as previously shown in FIG. 5.

The master node 60₂ is a node possessed by the enterprise at the order reception base receiving the order and providing the information products or services and is equipped with the application realizing the aforementioned peer-to-peer network architecture. The master node 60₂ exists together with the master node 60₂, as a background environment in the network realizing the peer-to-peer connection between the client terminals 50₁, 50₂, 50₃, 50₄ and the order reception database 70. To be more specific, the master node 60₂ is connected to the DMZ layer likewise the collector node 60₁, and may be a public node from the viewpoint of the client terminals 50₁, 50₂, 50₃, 50₄ or may be a computer different from the public node.

The master node 60₂ is a node equipped with a management function so that a manager of this business process system can control members or authority for participation in a room. To be more specific, the master node 60₂ performs authentication of access to the order reception database 70 to transfer the data maintained by the master node 60₁ to the appropriate order reception database 70. In other words, the master node 60₂ authenticates the validity of the client terminal, and transfers the data maintained by the collector node 60₁ according to the authentication result. Furthermore, the master node 60₂ transfers the data read from the order reception database 70 and maintained by the collector node 60₁ to the appropriate client terminals from among the client terminals 50₁, 50₂, 50₃, 50₄ through the firewall FW in order to send the data to those client terminals 50₁, 50₂, 50₃, 50₄.

The applications for realizing the collector node 60₁ and the master node 60₂ do not need to be implemented in physically separate computers but can be implemented in a single computer. In other words, the business process system is such that the node equipped with the application having a function of maintaining and sending the data to the appropriate destination exists as a network environment (background) in the network composed of the client terminals 50₁, 50₂, 50₃, 50₄ and the order reception database 70, which perform the peer-to-peer connection therein. The collector node 60₁ and master node 60₂ are formed as a concept totally different from that of the relay node in the peer-to-peer network.

The order reception database 70 corresponds to the order reception database 20 possessed by the enterprise at the order reception base ordering and providing the products or services, as previously shown in FIG. 7, and is equipped with the application realizing the aforementioned peer-to-peer network architecture. This order reception database 70 is connected to the LAN as a segment isolated from both the external open network layer and the DMZ layer through the firewall FW, and the client terminals 50₁, 50₂, 50₃, 50₄ cannot have direct access to the order reception database 70. The order reception database 70 receives the data transferred from the master node 60₂ sent from the client terminals 50₁, 50₂, 50₃, 50₄ through the firewall FW and temporarily maintained by the collector node 60₁, thereby recording this data in a predetermined area. The order reception database 70, furthermore, reads the appropriate data to be sent out of the recorded data to pass the read data to the master node 60₂ through the collector node 60₁ in the case of sending the recorded data to the client terminals 50₁, 50₂, 50₃, 50₄.

The order reception database 70 records the data on all of the business partners, thereby being required to maintain, at least, a business partner table indicating the information on a partner enterprise as a customer possessing the client terminals 50₁, 50₂, 50₃, 50₄, a customer product table indicating the information on the information products or the service dealt by the customer, a product table indicating the information on the product such as the information product and the service dealt by the order reception database 70 itself as the order source, an individual unit price table indicating the information on an individual unit price of each product, a unit price table indicating the information on a unit price of product of the received order, a currency table indicating the information on a currency dealt relating to an order, a delivery recipient indicating the information on a delivery recipient of a product, a conversion rate indicating the information on a rate in the case of different currencies, an order details table indicating the information on details about an order reception, an installment payment details table indicating the information on details in the case of payment by installments, an installment payment response table indicating the information on details about response concerning a delivery date in the case of payment by installments, an analysis table indicating the information on analysis of a statistic about a transaction condition, an application purpose table indicating the information on an application purpose of a product, a city table indicating the information on a city to which a client belongs, an area table indicating the information on an area to which a client belongs, an enterprise group table indicating the information on an enterprise group in the case of a client belonging to an enterprise, a user table for analysis indicating the information on a user being subject to an analysis, and the like.

On the other hand, each of the client terminal 50₁, 50₂, 50₃, 50₄ also possesses a database, not shown, for recording the data from the order reception database 70, but is required to record only the data concerning a business partner corresponding to the client terminal itself, thereby being required to possess at least the business partner table, the customer product table, the product table, the individual unit price table, the order details table, the installment payment details table, and the installment response table from among the various tables possessed by the order reception database 70.

The order reception base terminal 80 is possessed by the order reception base receiving the order and providing the information products or services and being equipped with the application realizing the aforementioned peer-to-peer network architecture. This order reception base terminal 80 is a network that is independent from the system composed of the collector node 60₁, the master node 60₂, and the order reception database 70. The order reception base terminal 80 is connected to the in-house network connected to the open network layer, i.e., the DMZ layer and the LAN layer through the firewall FW, and has the authority to access the order reception database 70 through the collector node 60₁ and the master node 60₂ in order to manage various business operations such as ordering or the like. For example, the order reception base terminal 80 manages an ordering condition and the like by receiving the ordering data from the collector node 60₁ according to an ordering and displaying the data on the screen.

Each of the client terminals 90₁, 90₂, 90₃ is possessed by an enterprise at an order reception base receiving the order and providing the information products or services and equipped with the application realizing the aforementioned peer-to-peer network architecture. Each of the client terminals 90₁, 90₂, 90₃ is connected to the in-house network in a manner similar to the order reception base terminal 80, and can transmit and receive the data by getting access to the order reception database 70.

In the business process system as descried above, direct access from a WAN (Wide Area Network) layer, such as the Internet connected to the client terminals 50₁, 50₂, 50₃, 50₄, to the LAN connected to the order reception database 70 is established not through the firewall, but through the DMZ layer as an intermediate network layer connected to the collector node 60₁ and the master node 60₂ is formed, so that the peer-to-peer technology is introduced to a B2B (Business to Business) system by constructing the business process system as a system divided into those three layers, and especially a load on the order reception database 70 can be reduced to remarkably improve performance by dividing the enterprise system at the order reception base into the DMZ layer and the LAN layer, and thus direct access to the order reception database 70 can be prevented, thereby being able to remarkably improve security.

Furthermore, in this business process system, the collector node 60₁ temporarily maintains the data from the client terminals 50₁, 50₂, 50₃, 50₄ and thereafter transfers the data to the order reception database 70, thereby not requiring the client terminals 50₁, 50₂, 50₃, 50₄ to reinput the data even where the connect session between the client terminals 50₁, 50₂, 50₃, 50₄ and the order reception database 70 is disconnected at some midpoint in communication, so that reliable communication can be realized.

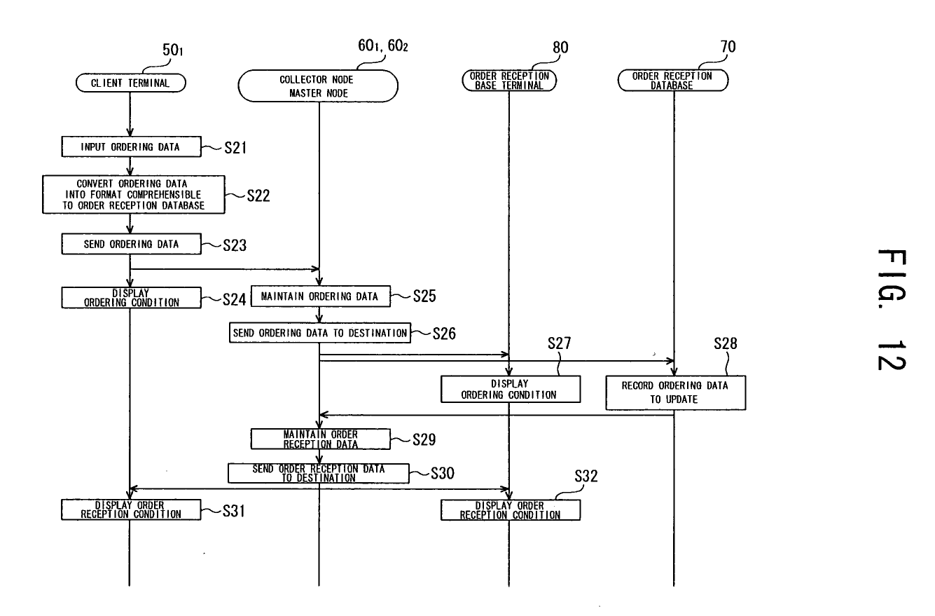

The business process system described above, as shown in FIG. 10, for example, can be applied in the transmission and reception of various pieces of business data between a customer-related department and an enterprise owned department in a flow of product-life cycle. Especially, the business process system is suitably applied in a mass-production phase of information products and/or services composed of a forecast process, an ordering process, a delivery process such as a response concerning a delivery date and/or a quantity, an invoice, notification of B/L, and the like, and processes after a delivery, such as notification of defective occurrence, a receipt and inspection, and the like.

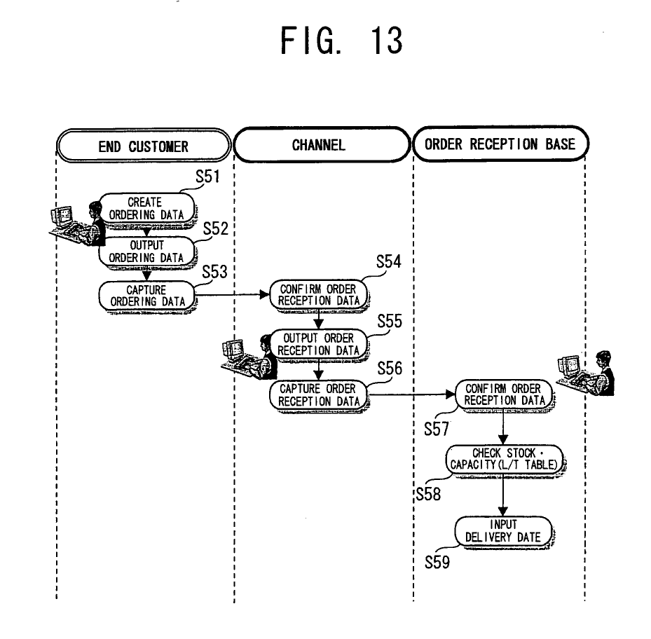

FIG. 11 shows one example of a sequence until receipt of an order through a client terminal 50₁ possessed by the end customer. In addition, the end customer possessing the client terminal 50₁ has an original system for ordering and purchasing information products or services.

First, the end customer creates ordering data in an arbitrary format by using the original system at the step S1, as shown in FIG. 11.

Subsequently, the end customer converts the ordering data into a format comprehensible to the order reception database 70 by using a function of the translator 12 of the aforementioned client terminal 50₁ equipped with the application at the step S2 and then sends the ordering data to the collector node 60₁ by using a function of the data carrier section 13 at the step S3.

Accordingly, where receiving the ordering data, the collector node 60₁ and the master node 60₂ temporarily maintain the ordering data at the step S4, and send the ordering data to the order reception database 70 as a destination at the step S5 as well as to the order reception base terminal 80. The order reception base terminal 80 displays an ordering condition by using a function of the screen section 11 based on the ordering data from the collector node 60₁ at the step S6.

On the other hand, upon reception of the ordering data transferred from the collector node 60₁ by using a function of the data carrier section 21, the order reception database 70 records this ordering data by using a function of the database management section 22 at the step S7 to update the contents of the database. The order reception database 70 then sends the order reception data to the collector node 60₁.

Accordingly, where receiving the order reception data from the order reception database 70, the collector node 60₁ and the master node 60₂ temporarily maintain the order reception data at the step S8 and send the order reception data to the client terminal 50₁ as a destination at the step S9 as well as to the order reception base terminal 80.

The client terminal 50₁ displays an order reception condition by using a function of the screen section 11 based on the order reception data from the collector node 60₁ to terminate a sequence of procedural steps at the step S10. At the step S11, the order reception base terminal 80 also displays an order reception condition by using a function of the display section 11 based on the ordering data from the collector node 60₁ to terminate a sequence of procedural steps.

In the business process system, the aforementioned transmission and reception of the business data among the client terminal 50₁ possessed by the end customer having the original system, the collector node 60₁ and the master node 60₂, the order reception database 70, and the order reception base terminal 80 makes it possible to receive an order from the end customer.

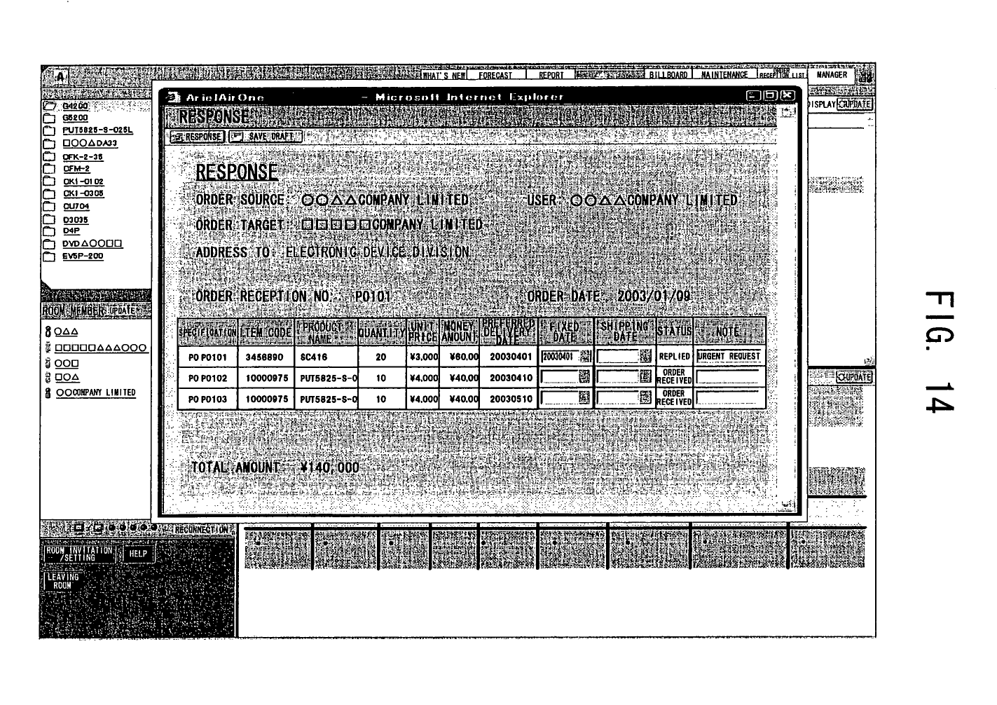

Furthermore, FIG. 12 shows a sequence until receipt of an order through the client terminal 50₁ in the case where the end customer possessing the client terminal 50₁ does not have the original system for ordering and purchasing the information products or services.

In such a case, the end customer inputs the ordering data at the step S21 by using a function of the screen section 11 of the client terminal 50₁ equipped with the aforementioned application.

Subsequently, the end customer converts the ordering data into a format comprehensible to the order reception database 70 by using the translator 12 of the client terminal 50₁ at the step S22, and thereafter sends the ordering data to the collector node 60₁ by using a function of the data carrier section 13 at the step S23. The client terminal 50₁ displays an ordering condition by using a function of the screen section 11 based on the sent ordering data at the step S24.

On the other hand, in the case of receiving the ordering data, the collector node 60₁ and the master node 60₂ temporarily maintain the ordering data at the step S25, and send the ordering data to the order reception database 70 as a destination at the step S26 as well as to the order reception base terminal 80. The order reception base terminal 80 displays an ordering condition by using a function of the screen section 11 based on the ordering data from the collector node 60₁ at the step S27.

Upon receiving the ordering data sent from the collector node 60₁ by using a function of the data carrier section 21, the order reception database 70 records this ordering data by using a function of the database management section 22 to update the contents of the database. The order reception database 70 then sends the order reception data to the collector node 60₁.

Accordingly, upon receiving the order reception data from the order reception database 70, the collector node 60₁ and the master node 60₂ temporarily maintains the order reception data at the step S29, and sends this order reception data to the client terminal 50₁ as a destination at the step S30 as well as to the order reception base terminal 80.

The client terminal 50₁ displays an order reception condition by using a function of the screen section 11 based on the order reception data from the collector node 60₁ at the step S31 to terminate a sequence of procedural steps. The order reception base terminal 80 also displays an order reception condition by using a function of the screen section 11 based on the order reception data from the collector node 60₁ at the step S32 to terminate a sequence of procedural steps.

In the business process system, the aforementioned transmission and reception the business data among the client terminal 50₁ possessed by the end customer not having the original system, the collector node 60₁ and the master node 60₂, the order reception database 70, and the order reception base terminal 80 makes it possible to receive an order from the end customer.

Explained finally are procedural steps from when the end customer makes an order through a channel such as an agency until when the order reception base side makes a response concerning a delivery date, in order to clarify a sequence of business images under the business process system.

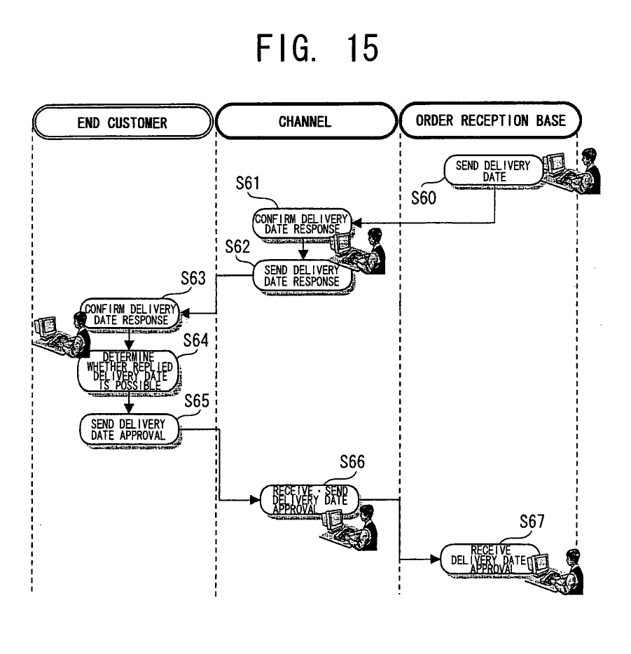

A process from an order to order-receipt is explained with reference to FIG. 13. That is, in FIG. 13, a process is explained in which the data flows from the end customer through the channel to the order reception base.

As shown in FIG. 13, the end customer creates the ordering data by using the client terminal equipped with the self-owned original system or application at the step S51.

Subsequently, the end customer coverts and outputs the ordering data in a form comprehensible to the order reception database by using the client terminal at the step S52.

The end customer sends the ordering data to the system possessed by a channel of an agency by using the client terminal at the step S53. Therefore, the ordering data is captured in the order reception database possessed by the aforementioned channel.

In addition, the end client may input the ordering data by using a function of the screen section 11 of the client terminal to pass this order to the channel.

The channel having received the ordering data confirms the order reception data on the screen by using the client terminal equipped with the self-owned application at the step S54. This procedural step corresponds to the previous step where the order reception base terminal 80 confirms an order reception condition at the step S11 in FIG. 11 or at the step S32 in FIG. 12.

Subsequently, the channel collects and organizes the ordering data from the plurality of clients at the step S55 to create the ordering data by using the self-owned original system or the client terminal, thereby outputting the ordering data after conversion into a format comprehensible to the order reception database 70.

The channel sends the ordering data using the client terminal to the system possessed by the order reception base at the step S56. Thus, the ordering data is captured and recorded in an order reception database possessed by the order reception base, corresponding to the order reception database 70 previously shown in FIG. 9.

In addition, the channel may input the ordering data by using a function of the screen section 11 of the client terminal to pass the ordering data to the order reception base.

The order reception base having received the ordering data confirms the order reception data on the screen at the step S57 by using the order reception base terminal equipped with the self-owned application corresponding to the order reception base terminal 80 previously shown in FIG. 9. This procedural step corresponds to the previous step where the order reception base terminal 80 confirms the order reception condition at the step S11 in FIG. 11 or at the step S32 in FIG. 12.

Subsequently, the order reception base confirms stocks, a production status, a capacity, and the like based on the order reception data at the step S58 to make an adjustment between factories or the like and the production department, thereby making a determination of a date on which shipment is possible.

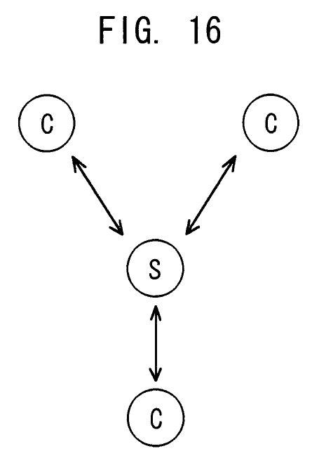

The order reception base inputs a delivery date at the step S59, determined using a function of the screen section 11 of the order reception base terminal. To be more specific, a delivery date response dialog as shown in FIG. 14, for example, on the display screen of the order reception base terminal. The order reception base inputs necessary information in this delivery date response dialog.

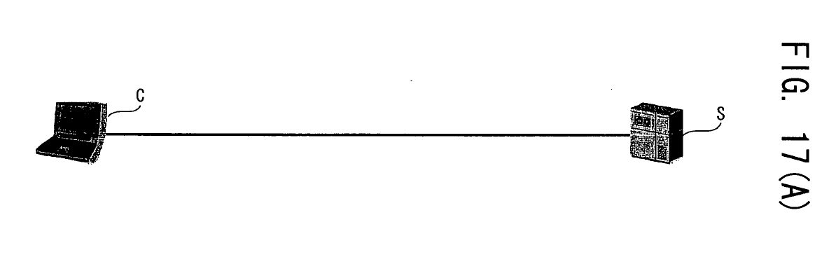

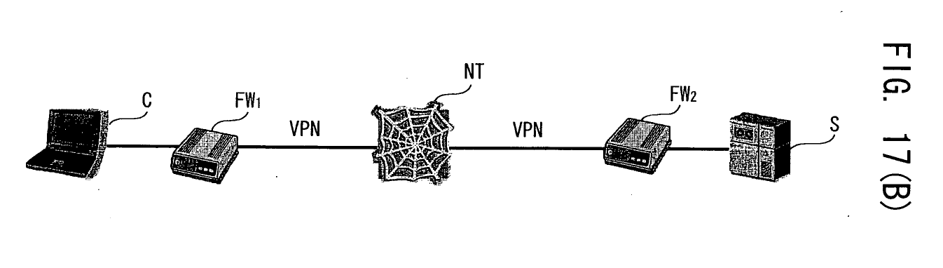

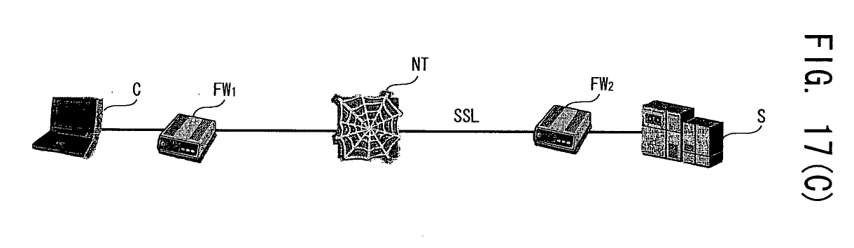

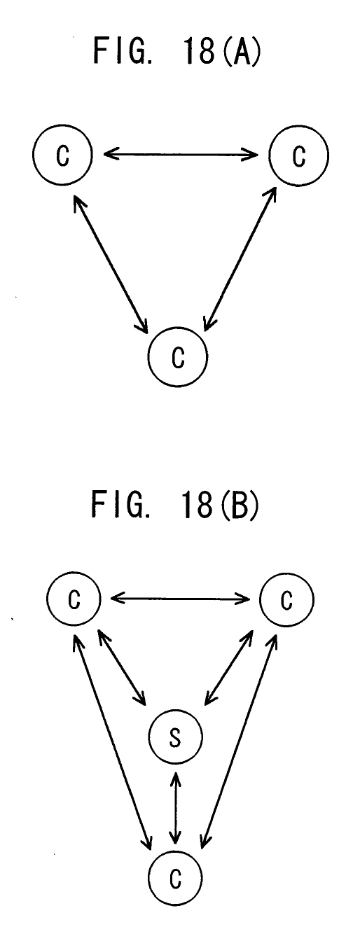

The process described above is that from an order to order-receipt. The process from the order-receipt to a delivery response will be explained next with reference to FIG. 15. That is, FIG. 15 shows a process where the data flows from the order reception base through the channel to the end customer, and furthermore, a process where the data is flown from the end customer through the channel to the order reception base.

The order reception base sends delivery date data indicating a determined delivery date to the system possessed by the channel by using the order reception base terminal at the step S60, as shown in FIG. 15.

The channel having received the delivery-time data confirms the replied delivery date at the step S61 by confirming the delivery date data on the screen by using the client terminal, thereby make a fine adjustment of arrival date to the client.

The channel sends the delivery date data indicating the delivery date adjusted using the client terminal to the system possessed by the channel at the step S62.

The end customer, having received the delivery date data, confirms the replied delivery date by confirming the delivery date data on the screen by using the client terminal at the step S63.

Subsequently, the end customer makes a judgment at the step S64 as to whether the replied delivery date is to be accepted or not, and in the case of acceptance of the delivery date, the end customer sends using the client terminal a status indicating acceptance of the delivery date to the system possessed by the channel.

The channel having received this status sends this status to the system possessed by the channel by using the client terminal at the step S66.

The order reception base receives this status by using the order reception base terminal and confirms it on the screen to terminate a series of processes.

As described above, in this business process system, a series of procedural steps from an order to a delivery date response can be realized seamlessly among the end customer, the channel, and the order reception base.

As described above, in the business process system described as an embodiment of this invention, the data sent by the client terminals 50₁, 50₂, 50₃, 50₄ connected to the open network layer is recorded in the order reception database 70 at the order reception base through the collector node 60₁ connected to the DMZ layer at the order reception base as a segment isolated from both the open network layer and the network layer inside the order reception base, in which a peer-to-peer connection is established between the collector node 60₁ and the client terminals 50₁, 50₂, 50₃, 50₄.

As described above, in this business process system, the client terminals 50₁, 50₂, 50₃, 50₄ execute the application to reduce a load on the order reception database 70, thereby enabling performance to be remarkably improved, and direct access to the order reception database 70 can be avoided by interposing the corrector node 60₁, thereby enabling security to be remarkably improved. Furthermore, in this business process system, the collector node 60₁ temporarily maintains the data from the client terminals 50₁, 50₂, 50₃, 50₄ and thereafter transfers the data to the order reception database 70, thereby not requiring the client terminals 50₁, 50₂, 50₃, 50₄ to reinput the data even where the connect session between the client terminals 50₁, 50₂, 50₃, 50₄ and the order reception database 70 is disconnected at some midpoint in communication, so that the reliable communication can be realized.

In this business process system, furthermore, the client terminals send the data to be sent after converting the data into a predetermined format, so that this business process system can coexist with an existing system even where an enterprise as an order source has already constructed the existing system.

As described above, the business process system can realize transactions among a large number of enterprises under a serverless condition at a low price with high security by using the peer-to-peer technology, which has been considered impractical.

Further, this invention is not limited to the aforementioned embodiment. In the aforementioned embodiment, for example, the system in which various types of nodes are connected to a network structure as shown in FIG. 9 was explained. In this invention, however, a Web server, for example, may be installed in the DMZ layer or a plurality of databases such as a design database or the like may be installed in the LAN layer.

A transaction concerning ordering was mainly explained in the aforementioned embodiment but it is a matter of course that this invention can by applied to other businesses such as a flow of product-life cycle, as previously shown in FIG. 10.

As described above, it goes without saying that this invention can be arbitrarily modified without departing from the scope of this invention.

What is claimed is:

1. A business process system for transmitting and receiving various pieces of business data by connecting an indefinitely large number of enterprises through a network, comprising:
a client terminal possessed by an order source connected to an open network layer, the client terminal being equipped with an application for realizing an architecture of a peer-to-peer network architecture, and serving as a member participating in the peer-to-peer network;
an order reception database connected to a network layer located inside an order reception base as a segment isolated from the open network layer, the order reception database being equipped with the application connecting to the client terminal by a peer-to-peer connection upon execution of the application by the client terminal, the order reception database recording data sent from the client terminal and reading data to be sent out of from the recorded data; and
a node connected to an intermediate network layer at the order reception base serving as a segment isolated from both the open network layer and the network layer located inside, the node collecting and temporally maintaining the data sent from the client terminal or the data read out of the order reception database and transferring the data to an appropriate destination.

2. The business process system according to claim 1, wherein the application includes:
a screen function for providing a data recording function and a data display function;
a translation function for receiving data recorded upon execution of the screen function or arbitrarily-created data and for converting the data into a format comprehensible to the order reception database;
a data carrier function as a base function for maintaining security beyond a firewall as well as reliably transmitting and receiving data; and
a database management function for receiving data received upon execution of the data carrier function, for capturing the data in a predetermined area of a database, and for retrieving data recorded in the database.

3. The business process system according to claim 2, wherein the client terminal executes the translation function to receive the data recorded upon execution of the screen function or the arbitrarily-created data and to convert the data into a format comprehensible to the order reception database, and wherein the client terminal executes the data carrier function to establish a connect session to the order reception database through the node and to send the data converted with the translation function.

4. The business process system according to claim 3, wherein the order reception database executes the data carrier function to establish the connect session to the client terminal through the node and to receive data sent from the client terminal, and wherein the order reception database executes the database management function to receive and capture in a predetermined area of the database the data received upon execution of the data carrier function and to retrieve data recorded in the database.

5. The business process system according to claim 1, wherein the nodes are classified into a collector node composed of an information processing apparatus for collecting and temporarily maintaining data sent from the client terminal or data read out of the order reception database, and a master node composed of an information processing apparatus for performing authentication of access to the order reception database to transfer the data maintained by the collector node to an appropriate destination.

6. The business process system according to claim 1, further comprising an order reception base terminal connected to an in-house network at an order reception base connected to the open network layer, the intermediate network layer, and the inside network layer though a firewall, the order reception base terminal equipped with the application, wherein the order reception base terminal at least displays on a screen ordering data received through the node according to ordering to manage an ordering condition.

7. The business process system according to claim 1, wherein the open network layer is defined as a WAN layer, the intermediate network layer is defined as a DMZ layer, and the inside network layer is defined as a LAN layer.

8. A business process method for transmitting and receiving various pieces of business data by connecting an indefinitely large number of enterprises through a network, comprising steps of:
rendering a client terminal possessed by an order source connected to an open network layer, the client terminal being equipped with an application for realizing a peer-to-peer network architecture, and serving as a member participating in the peer-to-peer network, to convert data recorded through a screen or arbitrarily-created data into a format comprehensible to an order reception database at an order reception base and to send the converted data upon establishment of a connect session to the order reception database;
rendering a node connected to an intermediate network layer at the order reception base as a segment isolated from both the open network layer and a network layer located inside the order reception base, to collect and temporarily maintain data sent from the client terminal or data read out of the order reception database to transfer the data to an appropriate destination; and
rendering the order reception database connected to the network located inside a segment isolated from both the open network layer and the intermediate network layer, and the order reception database being equipped with the application, to establish a peer-to-peer connection with the client terminal upon execution of the application by the client terminal to record data which was sent from the client terminal and transferred from the node and to read and pass data to be sent out of the recorded data to the node.

9. An information processing apparatus installed to a business process system connecting an indefinitely large number of enterprises through a network and transmitting and receiving various pieces of business data, serving as a member participating in a peer-to-peer network, equipped with an application for realizing a peer-to-peer network architecture, and connected to an open network, the information processing apparatus comprising:
a screen section for executing a screen function defined as a function of the application and providing a data recording function and a data display function;
a translation section for executing a translation function defined as a function of the application by receiving the data recorded upon execution of the screen function or the arbitrarily-created data, and by converting the data in a format comprehensible to an order reception database at an order reception base; and
a data carrier section for executing a data carrier function defined as a function of the application and as a base function for reliably transmitting and receiving data with maintenance of security beyond a firewall,
wherein the translation section executes the translation function to convert the data recorded upon execution of the screen function or the arbitrarily-created data in the format comprehensible to the order reception database, and wherein the data carrier section executes the data carrier function to send the converted data by establishing a connect session to the order reception database.

10. An information processing apparatus installed to a business process system connecting a large number of enterprises through a network and transmitting and receiving various pieces of business data, wherein the information processing apparatus is connected to an intermediate network at an order reception base as a segment isolated from an open network layer connected to a client terminal equipped with an application for realizing a peer-to-peer network architecture and from an inside network at the order reception base serving as a member participating in a peer-to-peer network, and possessed by an order source, and wherein the information processing apparatus collects and temporally maintains data sent from the client terminal or data read out from the order reception database at the order reception base connected to the inside network layer and transfers the data to an appropriate destination.

11. An information processing apparatus installed to a business process system connecting an indefinitely large number of enterprises through a network and transmitting and receiving various pieces of business data, connected to a network layer located inside an order reception base isolated from an open network layer connected to a client terminal equipped with an application for realizing a peer-to-peer network architecture and possessed by an order source, serving as an order reception database at the order reception base, and equipped with the application, the information processing apparatus comprising:
a data carrier section for executing a data carrier function as a function of the application and as a base function for reliably transmitting and receiving data with maintenance of security beyond a firewall; and
a database management section for executing a database management function as a function of the application, receiving the data received upon execution of the data carrier function, capturing the data in a predetermined area of a database, and retrieving the data recorded in the database,
wherein the data carrier section executes the data carrier function to establish a connect session to the client terminal through the node connected to an intermediate network layer at an order reception base as a segment isolated from the open network layer and from the inside network layer and to receive data sent from the client terminal after conversion in a format comprehensible to the database and temporarily maintained and then transferred by the node, and wherein the database management section executes the database management function to receive the data received upon execution of the data carrier function, to capture the data in the predetermined area of the database, and to retrieve data recorded in the database.
